(19) United States
(12) Patent Application Publication
(10) Pub. No.: US 2004/0008986 A1
(43) Pub. Date: Jan. 15, 2004

(54) Optical transmitter module and optical transmitter apparatus

(76) Inventors: Haruki Yoneda, Yokohama-shi (JP); Hirotaka Oomori, Yokohama-shi (JP); Shigeo Hayashi, Yokohama-shi (JP)

Correspondence Address: MCDERMOTT, WILL & EMERY, 600 13th Street, N.W., Washington, DC, 20005-3096, US

(21) Appl. No.: 10/431,636

(22) Filed: May 8, 2003

(30) Foreign Application Priority Data
May 9, 2002 (JP) P2002-134602

(51) Int. Cl. H04B 10/08

(52) U.S. Cl. 398/33

(57) ABSTRACT

An optical transmitter apparatus includes a plurality of optical transmitter modules and a host controller. A module controller in each module determines whether the modulation current of a laser diode in the module is an anomaly, and also determines whether the temperature of the laser diode is an anomaly. If the modulation current or the temperature of the laser diode has an abnormal value, the module controller generates and sends an alarm signal from an alarm-outputting terminal. The alarm-outputting terminals of the modules are connected to an alarm-receiving terminal of the host controller in a wired-OR connection.

### BACKGROUND OF THE INVENTION

1. Field of the Invention

The present invention relates to an optical transmitter module and an optical transmitter apparatus.

2. Related Background of the Invention

Conventionally, one optical transmitter module and one host controller are mounted on a board and connected to each other in an optical transmitter apparatus used in a wavelength division multiplexing (WDM) optical communication system or the like. The optical transmitter module includes a laser diode. When the modulation current of the laser diode has an abnormal value, the optical transmitter module sends an alarm signal of an extraordinary operation of the laser diode to the host controller. Further, when the temperature of the laser diode has an anomaly, the optical transmitter module sends a temperature alarm signal of the laser diode to the host controller.

In the optical communication, it is desired to reduce a size of an optical transmitter apparatus. In order to reduce the size, it is preferable to install a plurality of optical transmitter modules on the same board.

However, when a plurality of optical transmitter modules are mounted on the same board, the connection between the host controller and respective modules is a one-to-N configuration (N is an integer more than one). In this case, in order to send the two alarm signals from each module to the host controller, it is necessary to allocate interrupt terminals or input terminals to the alarm signals from their respective modules. That is, 2N terminals are necessary on the host controller. This causes a problem that the count of terminals in the host controller increases.

Moreover, in a conventional optical transmitter module, the way for recovering from the alarm is to turn off the power of the module.

### SUMMARY OF THE INVENTION

It is an object of the present invention to restrict a count of terminals in a host controller to which a plurality of optical transmitter modules are connected.

An aspect of the present invention provides an optical transmitter apparatus. The optical transmitter apparatus comprises a plurality of optical transmitter modules for outputting optical signals and a host controller for controlling the transmitter modules. Each transmitter module includes an alarm-outputting terminal for outputting an alarm signal which indicates an anomaly of the transmitter module. The host controller includes an alarm-receiving terminal for receiving the alarm signal. The alarm-outputting terminals of the transmitter modules are connected to the alarm-receiving terminal of the host controller in a wired-OR configuration. The wired-OR configuration enables reducing the number of the alarm-receiving terminals in the host controller.

The host controller may further include a control-outputting terminal for outputting an alarm-masking signal which masks the alarm signal. Each of the transmitter modules may further include a control-receiving terminal for receiving the alarm-masking signal. The host controller may output the alarm-masking signal from the control-outputting terminal to the control-receiving terminal of at least one of the transmitter modules when receiving the alarm signal at the alarm-receiving terminal. Each transmitter module may mask the alarm signal when receiving the alarm-masking signal at the control-receiving terminal. In this case, the transmission of the alarm signal can be masked without turning off the power to the- transmitter module.

A serial transmission line may be connected between the control-outputting terminal and the control-receiving terminals. The host controller may identify the transmitter module which has output the alarm signal as follows. That is, the host controller outputs the alarm-masking signal from the control-outputting terminal to the control-receiving terminals of the transmitter modules via the serial transmission line when receiving the alarm signal. Then, the host controller which sequentially recognizes transmitter module that has masked the output of the alarm signal. In this case, the host controller can determine which of the transmitter modules has output the alarm signal.

When the transmitter module which has output the alarm signal is identified, the host controller may output a control signal, an optical output from the control-outputting terminal to the control-receiving terminal of the identified transmitter module. The control signal suppresses the optical output power of the optical signal. Each transmitter module suppresses the optical output power when receiving the control signal at the control-receiving terminal. This enables suppression of the optical output power of the transmitter module when an anomaly has occurred in the transmitter module.

Each transmitter module may include a laser diode for emitting the optical signal in response to a modulation current. Each transmitter module may output the alarm signal from the alarm-outputting terminal when the modulation current or temperature of the laser diode has an anomaly. In this case, the number of the alarm signals outputted from each transmitter module may be one. Therefore, in each transmitter module, the number of the alarm-outputting terminals can be reduced.

Another aspect of the present invention provides an optical transmitter module for outputting an optical signal. The optical transmitter module comprises a laser diode for emitting the optical signal in response to a modulation current, a controller for generating an alarm signal that indicates an anomaly of the transmitter module in accordance with the modulation current and temperature of the laser diode, and an alarm-outputting terminal for outputting the alarm signal. The controller outputs the alarm signal from the alarm-outputting terminal when the modulation current or the temperature of the laser diode is an anomaly.

The transmitter module outputs a common alarm signal when the modulation current is an anomaly and when the temperature of the laser diode is an anomaly. Therefore, the number of the alarm-outputting terminals for outputting the alarm signals can be reduced. In a host controller, the number of the alarm-receiving terminals for receiving the alarm signals can be reduced by or in accordance with the reduction of the number of the alarm-outputting terminals in the transmitter module.

The optical transmitter module may further comprise a modulation current generator and a temperature sensor. The modulation current generator supplies the modulation current to the laser diode. The modulation current generator generates a monitor signal of the modulation current. The temperature sensor measures the temperature of the laser diode to generate a monitor signal. The module controller determines whether the modulation current is an anomaly based on the monitor signal of the modulation current. The module controller also determines whether the temperature of the laser diode is an anomaly based on the monitor signal of the temperature.

The optical transmitter module may further include a control-receiving terminal for receiving an alarm-masking signal which masks the alarm signal. A serial transmission line may be connected to the control-receiving terminal. The module controller masks the alarm signal when receiving the alarm-masking signal at the control-receiving terminal. In this case, the alarm signal can be masked without turning off the power to the transmitter module.

The module controller may suppress an optical output power of the laser diode when receiving a control signal to suppress the optical output signal at the control-receiving terminal. In this case, it is possible to suppress the optical output power of the optical signal when an anomalous operation has occurred in the transmitter module.

Further scope of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a block diagram showing an optical transmitter apparatus of a first embodiment.

FIG. 2 is a block diagram showing an optical transmitter module included in the optical transmitter apparatus according to the first embodiment.

FIG. 3 is a flowchart for explaining an alarm signal output process in a CPU of the optical transmitter module included in the optical transmitter apparatus according to the first embodiment.

FIG. 4 is a flowchart for explaining alarm processing in a host CPU included in the optical transmitter apparatus according to the first embodiment.

FIG. 5 is a block diagram showing an optical transmitter apparatus according to a second embodiment.

FIG. 6 is a block diagram showing an optical transmitter module included in the optical transmitter apparatus according to the second embodiment.

FIG. 7 is a flowchart for explaining alarm signal output/suppression process in a CPU of the optical transmitter module included in the optical transmitter apparatus according to the second embodiment.

FIG. 8 is a flowchart for explaining an alarm processing in a host CPU included in the optical transmitter apparatus according to the second embodiment.

### DESCRIPTION OF THE PREFERRED EMBODIMENTS

The preferred embodiments of the present invention will be described below in greater detail with reference to the accompanying drawings. To facilitate understanding, identical reference numerals have been used, where possible, to designate identical or equivalent elements that are common to the figures without repeating the overlapping descriptions.

First Embodiment

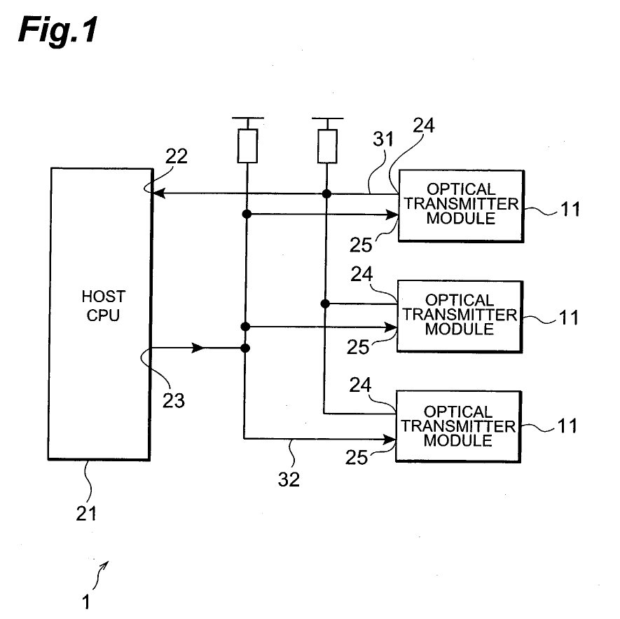

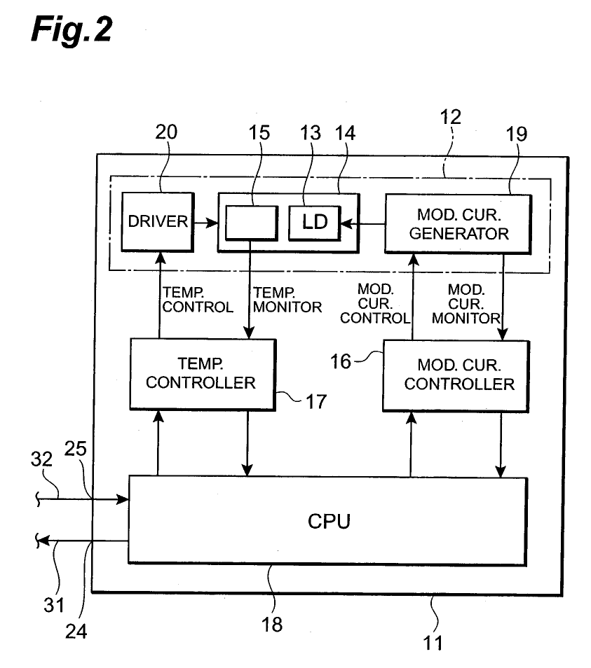

FIG. 1 is a block diagram showing an optical transmitter apparatus according to the first embodiment. The optical transmitter apparatus 1 has a plurality of optical transmitter modules 11, and a host CPU 21 as a host controller. The optical transmitter modules 11 and the host CPU 21 are mounted on the same circuit board (not shown) FIG. 2 is a block diagram showing the transmitter module 11 included in the transmitter apparatus 1. As shown in FIG. 2, each transmitter module 11 includes a main part 12, a modulation current controller 16, a temperature controller 17, a CPU 18, an alarm-outputting terminal 24 and a control-receiving terminal 25.

The main part 12 includes a laser diode 13, an temperature regulator 14 and a temperature sensor 15. The temperature regulator 14 regulates the temperature of the laser diode 13 to a constant value. A Peltier element may be used as the temperature regulator 14. The laser diode 13 and the temperature sensor 15 are directly or indirectly mounted on the temperature regulator 14. The temperature sensor 15 detects the temperature of the laser diode 13 and generates a temperature monitor signal. A thermistor may be used as the temperature sensor 15.

The modulation current controller 16 receives a control signal from the CPU 18 to control a modulation current generator 19. The modulation current generator 19 receives a control signal from the modulation current controller 16 to generate a modulation current, and also detects the modulation current to generate a monitor signal of the modulation current. The monitor signal is output to the modulation current controller 16. Correspondingly, the modulation current controller 16 feedbacks the monitor signal so as to keep the modulation current to be a predetermined amplitude. Further, the modulation current controller 16 outputs the monitor signal to the CPU 18.

The temperature controller 17 receives a control signal from the CPU 18 to generate a signal for controlling a driver 20 for the temperature regulator. The driver circuit 20 receives the signal from the temperature controller 17 to adjust a supply current to the temperature regulator 14. Based on the monitor signal of the temperature sent from the temperature sensor 15, the temperature controller 17 feedbacks the monitor signal so as to keep the temperature of the regulator 14 to be a predetermined value. Further, the temperature controller 17 outputs the monitor signal to the CPU 18.

The CPU 18 is a module controller. The CPU 18 controls the entire operations of the transmitter module 11. The CPU 18 generates a control signal for changing the modulation current, and outputs the control signal to the modulation current controller 16. The CPU 18 also generates a control signal for changing the temperature of the temperature regulator 14, and outputs the control signal to the temperature controller 17.

The CPU 18 determines whether the modulation current has an anomaly or not based on the monitor signal transmitted through the modulation current controller 16. In addition, the CPU 18 determines whether the temperature of the laser diode 13 has an anomaly or not based on the monitor signal transmitted through the temperature controller 17. When the modulation current of the laser diode 13 has an anomaly, or when the temperature of the laser diode 13 has an anomaly, the CPU 18 generates and outputs an alarm signal. The alarm signal is output from the alarm-outputting terminal 24 of the module 11.

Referring to FIG. 1 again, the alarm-outputting terminal 24 of each transmitter module 11 is connected to an alarm-receiving terminal (interrupt terminal) 22 of the host CPU 21 through a signal line 31. The signal line 31 is configured so that the alarm-outputting terminal 24 of each module 11 is connected to the alarm-receiving terminal 22 of the host CPU 21 in a wired-OR configuration. Depending on whether there is the alarm signal sent to the alarm-receiving terminal 22, the host CPU 21 determines whether an anomaly in either the modulation current of the laser diode 13 or the temperature of the laser diode 13 has occurred in any of the modules 11.

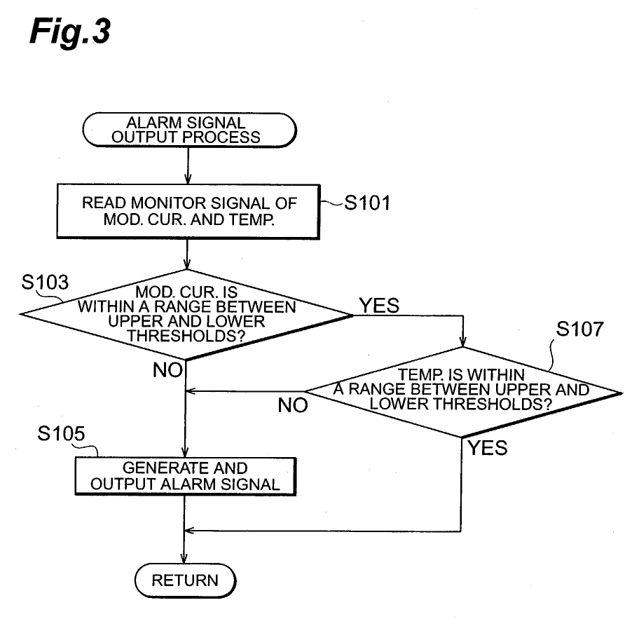

Referring to FIG. 3, a process for outputting an alarm signal executed by the CPU 18 of the transmitter module 11 will be described. FIG. 3 is a flowchart showing the process.

First, the CPU 18 reads the monitor signal of the modulation current and the monitor signal of the temperature at the step S101. The CPU 18 determines at step S103 whether the modulation current is within a range between an upper and a lower threshold. If the modulation current is not within the range between the upper and the lower thresholds, that is, if the modulation current has an anomaly (“NO” in S103), the CPU 18 generates and outputs an alarm signal from the alarm-outputting terminal 24 (S105).

On the other hand, if the modulation current is within the range between the upper and the lower thresholds (“YES” in S103), the CPU 18 determines whether the temperature is within a range between an upper and a lower threshold at step S107. If the temperature is not within the range between the upper and the lower thresholds, that is, if the temperature has an anomalous value (“NO” in S107), the CPU 18 generates and outputs an alarm signal from the alarm-outputting terminal 24 (S105). If the temperature is within the range between the upper and the lower thresholds (“YES” in S107), the control returns to S101, and the CPU 18 reads the modulation current and the temperature.

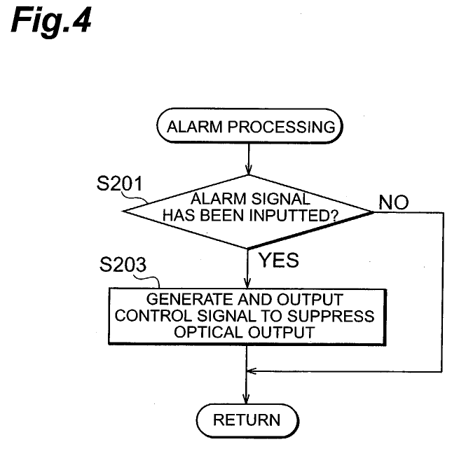

Referring to FIG. 4, alarm processing in the host CPU 21 will be described. FIG. 4 is a flowchart showing the alarm processing in the host CPU.

First, the host CPU 21 determines whether the alarm signal has been inputted into the alarm-receiving terminal 22 (S201). When the alarm signal is inputted (“YES” in S201), the host CPU 21 generates and outputs a control signal for reducing an optical output power from the control-outputting terminal 23 (S203). The control signal for reducing the optical output power is sent to each transmitter module 11. This control signal instructs the transmitter module 11 to reduce the optical output of the laser diode 13. The control signal enters the control-receiving terminals 25 of the transmitter modules 11 through a transmission line 32. The control-receiving terminals 25 are connected to the respective CPUs 18. When the control signal is inputted into the control-receiving terminal 25, the CPU 18 of each transmitter module 11 reduces the optical output of the laser diode 13.

As described above, the alarm-outputting terminals 24 of the respective modules 11 are connected to the single alarm-receiving terminal 22 of the host CPU 21 in a wired-OR configuration. Therefore, the number of the alarm-receiving terminals can be reduced in the host CPU 21.

Moreover, when the modulation current of the laser diode 13 has an anomaly and when the temperature of the laser diode 13 has an anomaly, the transmitter module 11 outputs an alarm signal common to these anomalies. Since a single alarm signal common to respective anomalies is output from each transmitter module 11, the number of the alarm-outputting terminals can be reduced in each optical transmitter module 11. Therefore, the number of the signal transmission lines for outputting alarm signals from the transmitter modules 11 to the host CPU 21 can be reduced. Correspondingly, the number of the alarm-receiving terminals in the host CPU 21 can be reduced too.

Second Embodiment

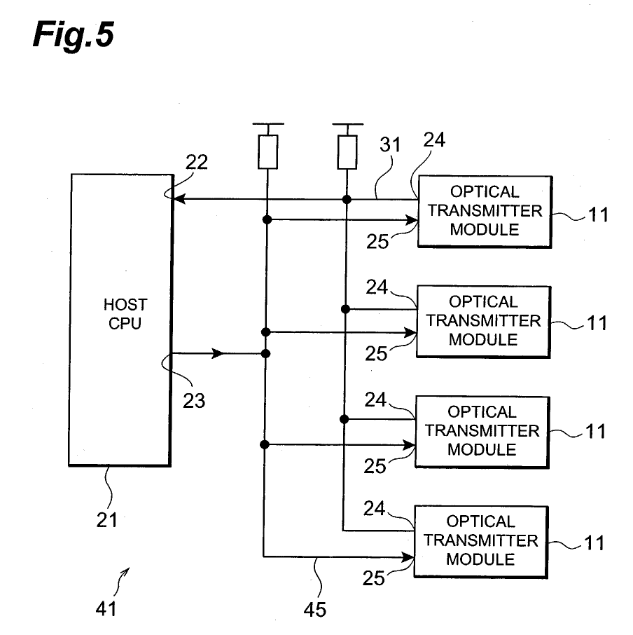

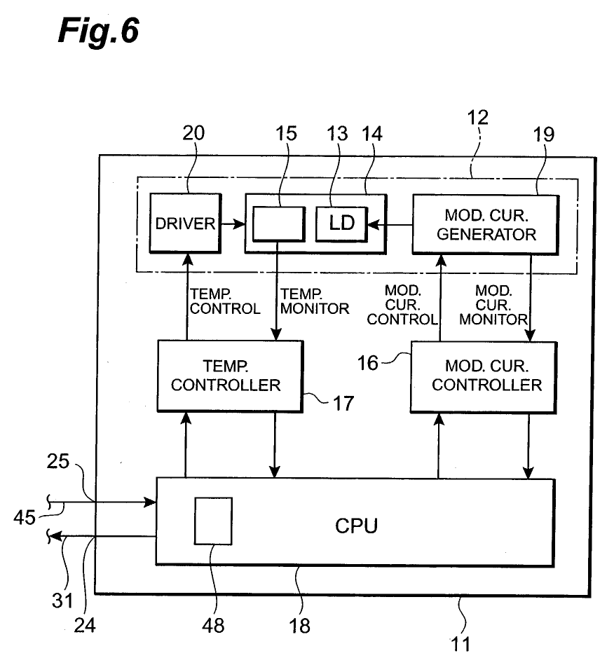

Referring to FIGS. 5 and 6, a second embodiment of the present invention will now be described. FIG. 5 is a block diagram showing an optical transmitter apparatus according to the second embodiment. FIG. 6 is a block diagram showing an optical transmitter module included in the optical transmitter apparatus according to the second embodiment.

The optical transmitter apparatus 41 according to the second embodiment is different from the first embodiment in that a plurality of optical transmitter modules are connected to a host CPU through a serial transmission line. More specifically, in the transmitter apparatus 41, the CPU 18 of each transmitter module 11 and a host CPU 21 are connected to each other through a serial transmission line 45 as shown in FIGS. 5 and 6. The serial transmission line 45 extends from the control-outputting terminal 23 of the host CPU 21 to the control-receiving terminals 25 of the transmitter modules 11.

The CPU 18 of each transmitter module 11 resets the alarm signal when receiving an alarm-masking signal from the host CPU 21 via the serial transmission line 45, as described later in detail. The CPU 18 has a register 48 for storing an alarm state. The register 48 has an alarm bit and a mask bit. When the modulation current of the laser diode 13 is an anomaly or when the temperature of the laser diode 13 is an anomaly, the CPU 18 sets the alarm bit in the register 48. In addition, the CPU 18 sets the mask bit in the register 48 when receiving an alarm-masking signal.

Upon receiving the alarm signal at the alarm-receiving terminal 22, the host CPU 21 sequentially checks the transmitter modules 11 by a polling to identify the transmitter module 11 that has output the alarm signal. The identifying process is performed for each optical transmitter module 11 as follows. The host CPU 21 sends the alarm-masking signal for resetting the alarm signal to one transmitter module 11 through the serial transmission line 45. When the alarm signal sent to the terminal 22 has been reset, the host CPU 21 determines that the transmitter module 11 to which the alarm-masking signal is sent has output the alarm signal. On the other hand, when the alarm signal sent to the terminal 22 is continuously set, the host CPU 21 determines that the transmitter module 11 to which the alarm-masking signal is sent has not output the alarm signal. The host CPU 21 sequentially determines on all the transmitter modules 11 to identify the module 11 that has output the alarm signal.

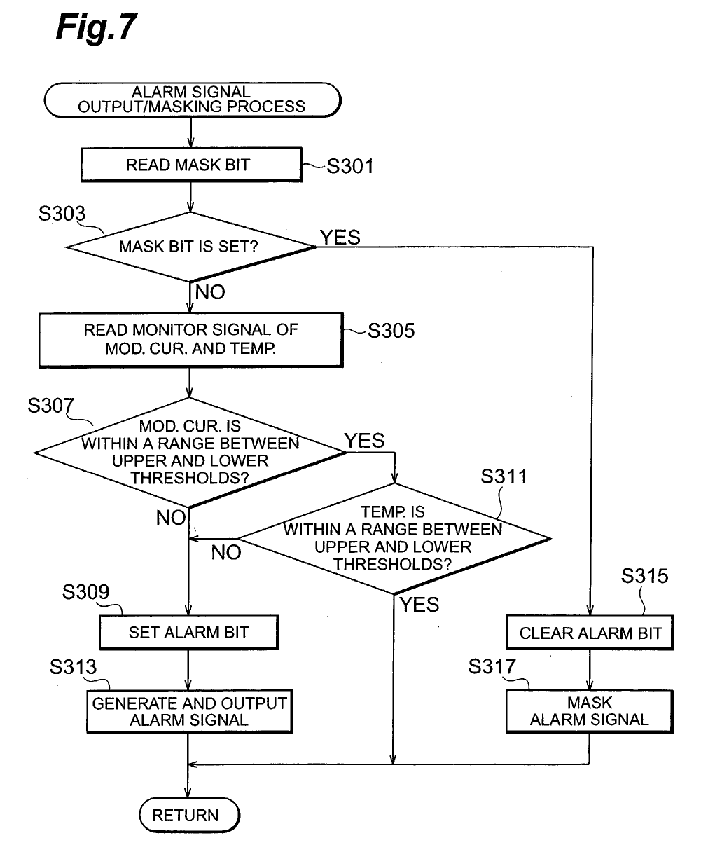

Referring to FIG. 7, an alarm signal output/masking process in the CPU 18 in each transmitter module 11 will now be described. FIG. 7 is a flowchart showing the alarm signal output/masking process.

First, the CPU 18 reads the mask bit in the register 48 (S301) . Then, the CPU 18 determines whether the mask bit has been set, that is, whether an alarm-masking signal has been received (S303) . If the mask bit has not been set, that is, if an alarm-masking signal has not been received (“NO” in S303), the CPU 18 reads the modulation current and the temperature (S305).

Next, the CPU 18 determines whether the modulation current is within a range between an upper and a lower threshold (S307). When the modulation current is not within the range between the upper and the lower thresholds, that is, if the modulation current is an anomaly (“NO” in S307), the CPU 18 sets the alarm bit in the register 48 (S309).

If the modulation current is within the range between the upper and the lower thresholds (“YES” in S307), the CPU 18 determines whether the temperature is within a range between an upper and a lower threshold (S311). If the temperature is not within the upper and the lower thresholds, that is, if the temperature is an anomaly (“NO” in S311), the process proceeds to S309, and the CPU 18 sets the alarm bit in the register 48. When the alarm bit has been set in S309, the CPU 18 generates and sends out an alarm signal from the alarm-outputting terminal 24 (S313).

On the other hand, if the mask bit has been set, that is, if an alarm-masking signal has been received (“YES” in S303), the CPU 18 clears the alarm bit in the register 48 (S315) and resets the alarm signal (s317).

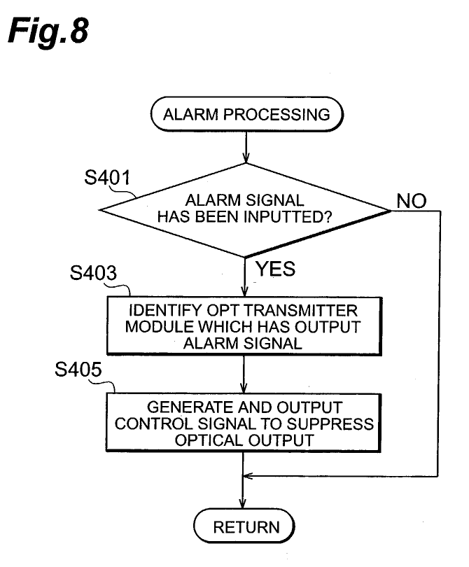

Referring to FIG. 8, alarm processing in the host CPU 21 will now be described. FIG. 8 is a flowchart showing the alarm processing.

First, the host CPU 21 determines whether the alarm signal has been inputted into the alarm-receiving terminal 22 (S401). If the alarm signal has been inputted thereto (“YES” in S401), the host CPU 21 identifies the transmitter module 11 which has output the alarm signal (S403). The identification is performed by the above-described procedure.

When the transmitter module 11 which has output the alarm signal is identified, the host CPU 21 generates and outputs a control signal to reduce an optical output from the control-outputting terminal 23 (S405) to the identified module 11. The control signal instructs the module 11 which has output the alarm signal to reduce the optical output of the laser diode 13. The control signal for reducing (suppressing) optical output passes through the serial transmission line 45 to be sent to the CPU 18 of the module 11 which has output the alarm signal. In response to the control signal, the CPU 18 controls the laser diode 13 to reduce the optical output of the laser diode 13.

Similar to the first embodiment, the alarm-outputting terminals 24 of the respective transmitter modules 11 are connected to the single alarm-receiving terminal 22 of the host CPU 21 in a wired-OR configuration. Accordingly, the number of the alarm-receiving terminals can be reduced in the host CPU 21.

Moreover, similar to the first embodiment, each transmitter module 11 includes the laser diode 13, and the transmitter module 11 outputs a common alarm signal when the modulation current or the temperature of the laser diode 13 has an anomaly. Since a single alarm signal is output from each module 11, the number of the alarm-outputting terminals 24 can be reduced in each module 11. Therefore, the number of the signal transmission lines for transmitting alarm signals from the modules 11 to the host CPU 21 can be reduced. Correspondingly, the number of the alarm-receiving terminals in the host CPU 21 can be reduced.

In addition, in the second embodiment, the control-outputting terminal 23 of the host CPU 21 is connected to the control-receiving terminals 25 of the respective transmitter modules 11 through the serial transmission line 45. When the host CPU 21 receives the alarm signal, the host CPU 21 sequentially outputs the alarm-masking signals to the transmitter modules 11 through the serial transmission line 45 and recognizes the transmitter module 11 which has masked the alarm signal, thereby identifying the transmitter module 11 which has output the alarm signal. Thus, on the host CPU 21 side, it is possible to determine which of the transmitter modules 11 has output the alarm signal.

In the second embodiment, when the alarm-masking signal has been received at the control-receiving terminal 25, the CPU 18 of the transmitter module 11 masks the alarm signal. This enables resetting the alarm signal without turning off the power to the module.

The present invention is not limited to the above-described embodiments. For example, the number of the optical transmitter modules 11 connected to the single host CPU 21 is not limited to the numbers in the first and second embodiments.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical transmitter apparatus, comprising:
a plurality of optical transmitter modules, each of the optical transmitter modules outputting an optical signal and including an alarm-outputting terminal for outputting an alarm signal which indicates an anomaly of the optical transmitter module; and
a host controller for controlling the plurality of optical transmitter modules, the host controller including an alarm-receiving terminal for receiving the alarm signal,
wherein the alarm-outputting terminals of the plurality of optical transmitter modules are connected to the alarm-receiving terminal of the host controller in a wired-OR configuration.

2. The optical transmitter apparatus of claim 1,
wherein the host controller further includes a control terminal for outputting an alarm-masking signal which masks the alarm signal, and
wherein each of the plurality of optical transmitter modules further includes a control terminal for receiving the alarm-masking signal.

3. The optical transmitter apparatus of claim 2,
wherein the host controller outputs the alarm-masking signal from the control terminal of the host controller to the control terminal of at least one of the optical transmitter modules when receiving the alarm signal at the alarm-receiving terminal, and
wherein each of the optical transmitter modules masks the alarm signal when receiving the alarm-masking signal at the control terminal of the transmitter module.

4. The optical transmitter apparatus of claim 3,
wherein a serial transmission line is connected between the control terminal of the host controller and the control terminals of the transmitter modules, and
wherein the host controller sequentially outputs the alarm-masking signal from the control terminal of the host controller to the control terminals of the optical transmitter modules via the serial transmission line when receiving the alarm signal at the alarm-receiving terminal, the host controller recognizing the optical transmitter module which masks the alarm signal, thereby identifying the optical transmitter module which has output the alarm signal.

5. The optical transmitter apparatus of claim 4,
wherein the host controller outputs a control signal for suppressing an optical output power from the control terminal of the host controller to the control terminal of the identified optical transmitter module, and
wherein each of the optical transmitter modules suppresses the optical output power of the optical signal when receiving the control signal at the control terminal of the optical transmitter module.

6. The optical transmitter apparatus of claim 1,
wherein each of the optical transmitter modules further includes a laser diode for emitting the optical signal in response to a modulation current supplied to the laser diode, the optical transmitter module outputting the alarm signal from the alarm-outputting terminal when the modulation current or a temperature of the laser diode is an anomaly.

7. The optical transmitter apparatus of claim 6,
wherein each of the optical transmitter modules further includes:
a modulation current generator for supplying the modulation current to the laser diode and for generating a monitor signal of the modulation current;
a temperature sensor for measuring temperature of the laser diode to generate a monitor signal of the temperature; and
a controller for generating the alarm signal in accordance with the modulation current and the temperature of the laser diode,
wherein the controller receives the monitor signal of the modulation current from the modulation current generator to determine whether the modulation current is an anomaly, and receives the monitor signal of the temperature from the temperature sensor to determine whether the temperature of the laser diode is an anomaly, and
wherein the controller outputs the alarm signal from the alarm-outputting terminal to the alarm-receiving terminal of the host controller when the modulation current or the temperature of the laser diode is an anomaly.

8. The optical transmitter apparatus of claim 6,
wherein the host controller further includes a control-outputting terminal for outputting an alarm-masking signal which masks the alarm signal, and
each of the optical transmitter modules further includes a control-receiving terminal for receiving the alarm-masking signal.

9. The optical transmitter apparatus of claim 8,
wherein the host controller outputs the alarm-masking signal from the control-outputting terminal to the control-receiving terminal of at least one of the optical transmitter modules when receiving the alarm signal at the alarm-receiving terminal, and
wherein the optical transmitter module masks the alarm signal when receiving the alarm-masking signal.

10. The optical transmitter apparatus of claim 9,
wherein a serial transmission line is connected between the control-outputting terminal and the control-receiving terminals, and
wherein the host controller sequentially outputs the alarm-masking signal from the control-outputting terminal to the control-receiving terminals of the optical transmitter modules via the serial transmission line when receiving the alarm signal at the alarm-receiving terminal, the host controller recognizing the optical transmitter module which has masked the alarm signal, thereby identifying the optical transmitter module which has output the alarm signal.

11. The optical transmitter apparatus of claim 10,
wherein the host controller outputs a control signal for suppressing an optical output power from the control-outputting terminal to the control-receiving terminal of the identified optical transmitter module, and
wherein each of the optical transmitter modules suppresses the optical output power of the optical signal when receiving the control signal at the control-receiving terminal.

12. An optical transmitter module for outputting an optical signal, comprising:
a laser diode for emitting the optical signal in response to a modulation current supplied to the laser diode;
a controller for generating an alarm signal which indicates an anomaly of the optical transmitter module in accordance with the modulation current and a temperature of the laser diode; and
an alarm-outputting terminal for outputting the alarm signal,
wherein the controller outputs the alarm signal from the alarm-outputting terminal when the modulation current or the temperature of the laser diode is the anomaly.

13. The optical transmitter module of claim 12, further comprising:
a modulation current generator for supplying the modulation current to the laser diode and for generating a monitor signal of the modulation current; and
a temperature sensor for measuring the temperature of the laser diode to generate a monitor signal,
wherein the controller determines whether the modulation current is the anomaly based on the monitor signal of the modulation current, and determines whether the temperature of the laser diode is the anomaly based on the monitor signal of the temperature.

14. The optical transmitter module of claim 12, further comprising a control-receiving terminal for receiving an alarm-masking signal which masks the alarm signal.

15. The optical transmitter module of claim 14, wherein the control-receiving terminal is connected to a serial transmission line.

16. The optical transmitter module of claim 14, wherein the controller suppresses an optical output power of the laser diode when receiving an output-suppressing signal at the control-receiving terminal.
